(19) United States
(12) Patent Application Publication
(10) Pub. No.: US 2013/0240471 A1
(43) Pub. Date: Sep. 19, 2013

(54) STORAGE SYSTEM

(71) Applicants: Ronald James Wiese, Crystal Lake, IL (US); Darren M. Baughman, Yorkville, IL (US)

(72) Inventors: Ronald James Wiese, Crystal Lake, IL (US); Darren M. Baughman, Yorkville, IL (US)

(21) Appl. No.: 13/423,524

(22) Filed: Mar. 19, 2012

(51) Int. Cl. A47F 5/00; F16D 1/00

(52) U.S. Cl. 211/134; 403/364

(57) ABSTRACT

A shelving system is disclosed that couples together a pallet storage rack and a bulk storage rack. The pallet storage rack includes an upstanding post with structure different than the upstanding post for the bulk storage rack. Accordingly, the shelving system includes at least a beam having first and second ends, where the first end is adapted to couple with a pallet storage rack, and where the second end is adapted to couple with a bulk storage rack. The disclosed structure therefore couples together the bulk storage and pallet storage racks to conserve space and provide a more convenient, stable, and efficient storage system.

### TECHNICAL FIELD OF THE INVENTION

The present application relates generally to storage containers and shelving. More particularly, the present application relates to a connecting structure that couples together bulk storage and pallet storage racks.

### BACKGROUND OF THE INVENTION

Industrial shelving units include a variety of modular structures to fit the particular need of the shelving unit. Existing shelving units include upwardly extending posts that stabilize a platform extending between the posts. Objects, such as boxes or pallets, rest on top of the platform until the objects are needed from the storage facility. Shelving units can also include side braces that support the structure of the unit.

Common industrial shelving units include pallet storage racks and bulk storage racks located independent of one another. Pallet storage racks are adapted to store objects placed on a pallet and transported to the rack on, for example, a forklift. Bulk storage racks, however, are adapted to store objects that can be loaded onto the rack by hand, for example. Pallet storage racks are considered more “heavy duty” than bulk storage racks due to the added weight of the pallet that can be delivered via a forklift when resting on the platform. As a result, pallet storage racks and bulk storage racks include different and non-interchangeable connection mechanisms disposed between the upstanding posts and the beams extending across the platform.

Storage facilities typically include both pallet and bulk storage racks, and many times include both of these racks within close proximity. To conserve space, the racks are usually placed as close to one another as possible, but typically with some wasted space in between. As a result, a need exists for a structure that couples pallet and bulk storage racks together in a manner that better utilizes the space of the storage facility. Also, linking together pallet storage and bulk storage racks results in greater structural stability of the rack configuration.

### SUMMARY OF THE INVENTION

The present application relates to a shelving system that couples a pallet storage rack and a bulk storage rack. Conventionally, a post disposed on the pallet storage rack includes a different receiving structure than a post disposed on the bulk storage rack. The system of the present application therefore includes a beam having first and second ends, where the first end is adapted to couple with an upstanding post for a pallet storage rack, and the second end is adapted to couple with an upstanding post for a bulk storage rack. The structure of the present application couples the bulk storage and pallet storage racks to conserve space and provide a more convenient, stable, and efficient storage system.

The present application discloses a connecting structure including a beam having first and second ends; a bulk connector disposed at the first end and adapted to couple to an engagement portion of a bulk post, and a pallet connector disposed at the second end and adapted to engage a keyhole of a pallet post.

The present application also includes a shelving system including a pallet shelf having a plurality of pallet posts having a keyhole; a platform extending between at least two of the plurality of pallet posts; a bulk shelf including a plurality of bulk posts each including an engagement portion and a beam having first and second ends, a bulk connector disposed at the first end and adapted to couple to the engagement portion; and a pallet connector disposed at the second end and adapted to engage the keyhole of a pallet post.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a front perspective view of a rack according to an embodiment of the present application.

FIGS. 2A and 2B are perspective views of an embodiment of a beam with a bulk storage connector and a pallet storage connector according to an embodiment of the present application.

FIG. 3 is a perspective view of a pallet connector according to an embodiment of the present application.

FIGS. 4A and 4B are perspective and side views, respectively, of a bulk connector according to an embodiment of the present application.

FIG. 5 is a perspective view of a beam according to an embodiment of the present application.

FIGS. 6A and 6B are perspective and enlarged perspective views, respectively, of a post for a pallet storage rack according to an embodiment of the present application.

FIGS. 7A and 7B are perspective and enlarged perspective views, respectively, of a post for a bulk storage rack according to an embodiment of the present application.

FIG. 8A is a perspective view of the coupling between the bulk connector and the bulk post.

FIG. 8B is a perspective view of the coupling between the pallet connector and the pallet post.

### DETAILED DESCRIPTION OF THE EMBODIMENTS

While this invention is susceptible to embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to the embodiments illustrated.

The present application relates to a shelving system that couples together a pallet storage rack and a bulk storage rack. In general, a pallet storage rack includes an upstanding post different than a post included in a bulk storage rack. The system of the present application can include a beam having first and second ends, where the first end is adapted to couple with the pallet storage post and where the second end is adapted to couple with the bulk storage post. The structure of the present application therefore couples together the bulk storage rack and the pallet storage rack to conserve space and provide a more convenient, stable, and efficient storage system.

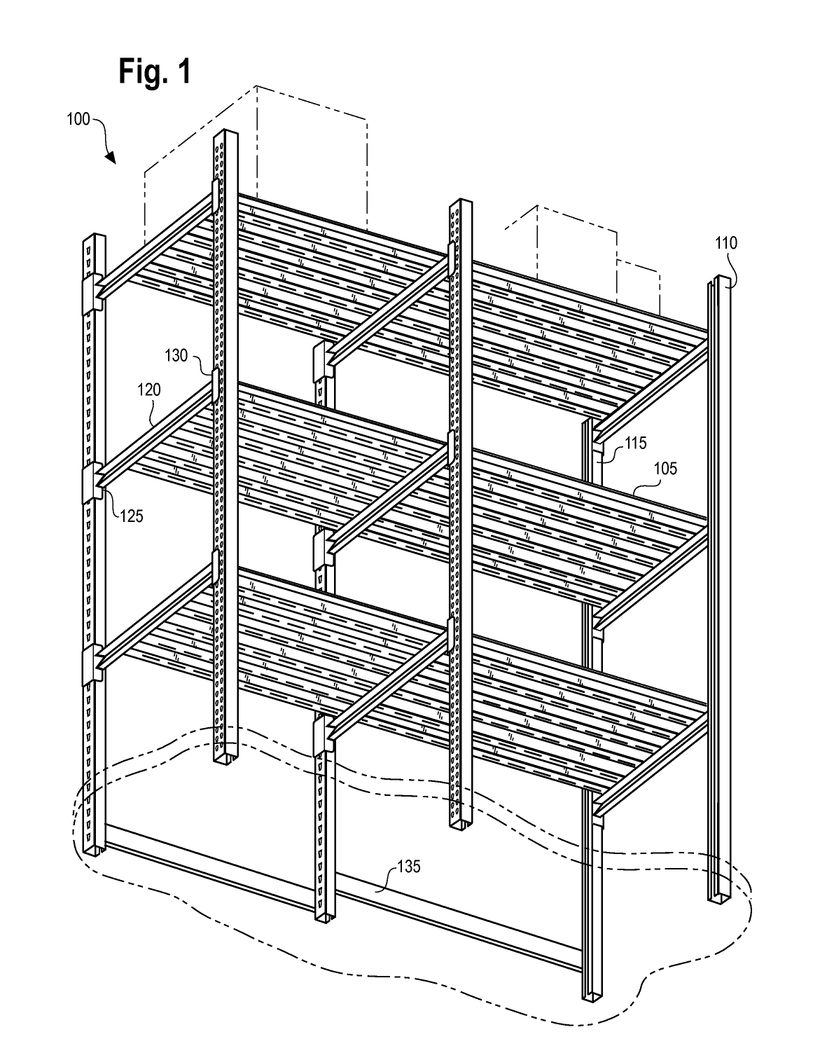

As shown in FIG. 1, the present application includes a rack 100 having a platform 105 and a plurality of pallet posts 110 and bulk posts 115. The platform 105 can extend between a plurality of the pallet posts 110 in a pallet storage rack, or between a plurality of bulk posts 115 in a bulk storage rack. As shown in FIG. 1, the platform 105 can also extend between a bulk post 115 on a first end of the platform 105, and a pallet post 110 on the second end of the platform so as to link a bulk storage rack to a pallet storage rack. A beam 120 can be provided to support the platform 105 between the pallet post 110 and bulk post 115, and can include a bulk connector 125 coupling the beam 120 to the bulk post 115, and a pallet connector 130 coupling the beam 120 to the pallet post 110. A brace 135 can extend between any of the pallet posts 110 and/or the bulk posts 115 to provide additional structural support to the rack 100.

As discussed below, the pallet post 110 includes a different structure for receiving the beam 120, compared to the receiving structure of the bulk post 115. As a result, the beam 120 can include first and second ends with different structure on the first and second ends for connecting with the receiving structures of the pallet post 110 and the bulk post 115. The beam 120 can therefore couple together a bulk storage rack to a pallet storage rack with different connecting structure on the first and second ends of the beam 120.

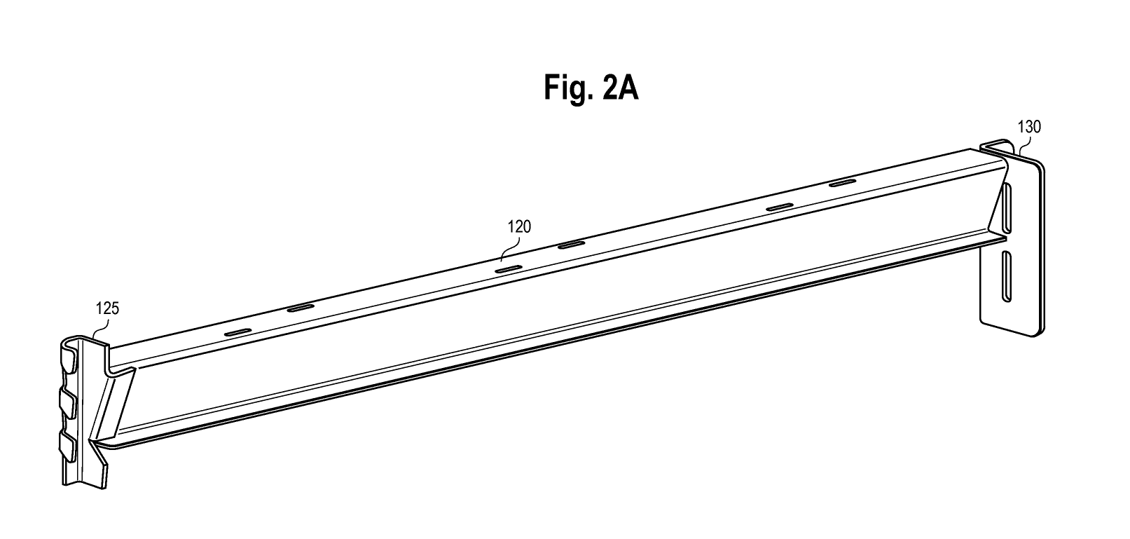

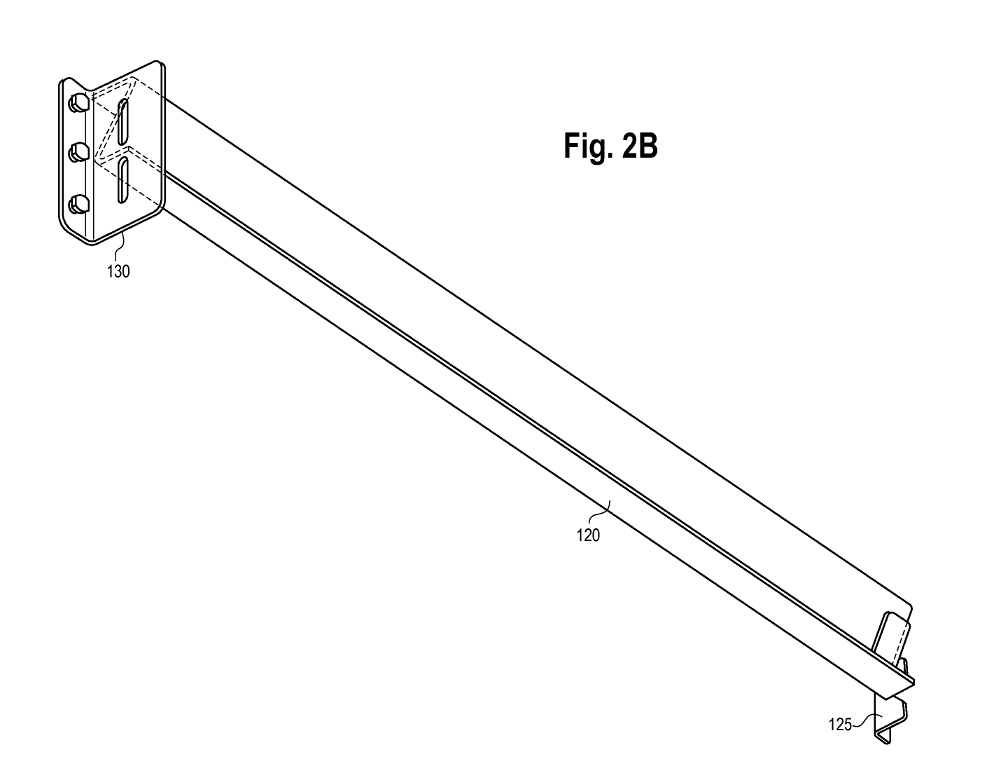

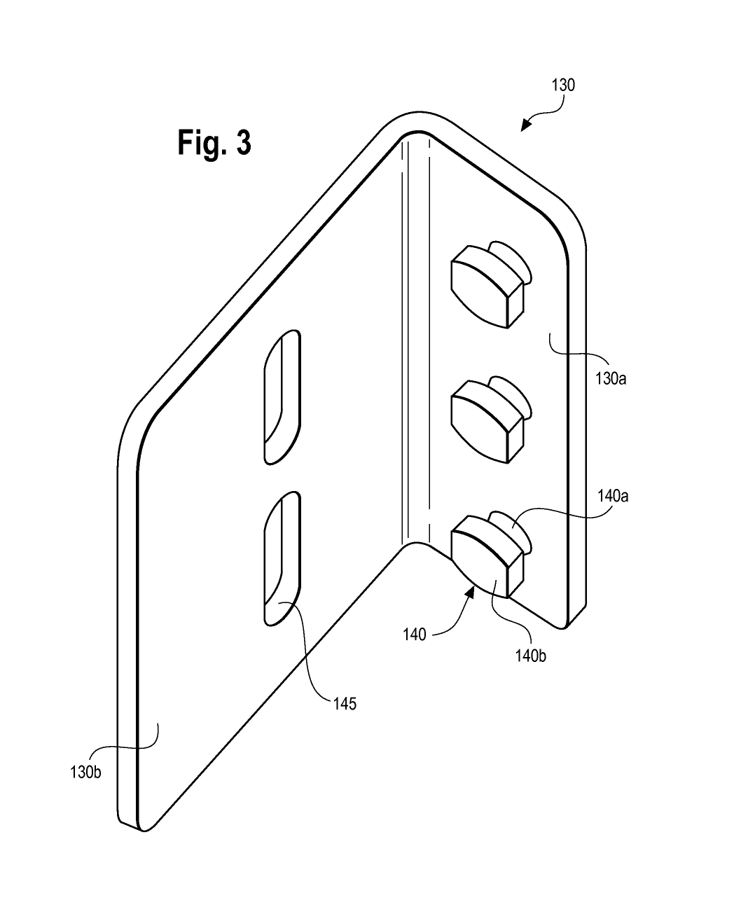

FIGS. 2A and 2B illustrate the beam 120 with the bulk connector 125 and the pallet connector 130 on opposite ends. FIG. 3 illustrates the pallet connector 130 in more detail, and FIGS. 4A and 4B illustrate the bulk connector 125 in more detail. For example, the pallet connector 130 can include a first face 130a and a second face 130b, and one or more protrusions 140 including a neck 140a and a head 140b extending from the neck 140a. The pallet connector 130 can also include one or more openings 145 provided on a surface extending from the second face 130b.

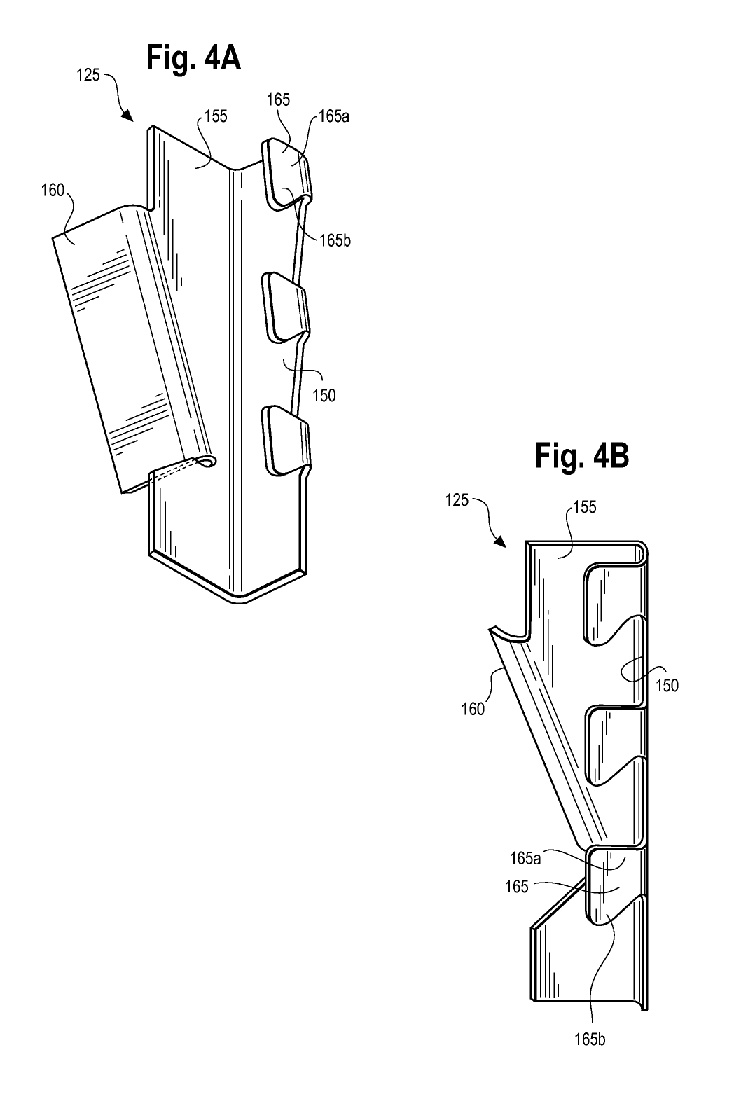

In an embodiment, the bulk connector 125 can include a main face 150 and a side face 155, with an extending face 160 angled substantially perpendicular to the side face 155. The bulk connector 125 can also include one or more fingers 165 having a main body 165a and a cam portion 165b extending from the main body 165a. As shown in FIG. 5, the beam 120 can include a top face 120a, a connecting face 120b, and a bottom face 120c. Holes 170 may also be provided on the top face 120a, or can be provided on any combination of the three faces 120a, 120b, 120c.

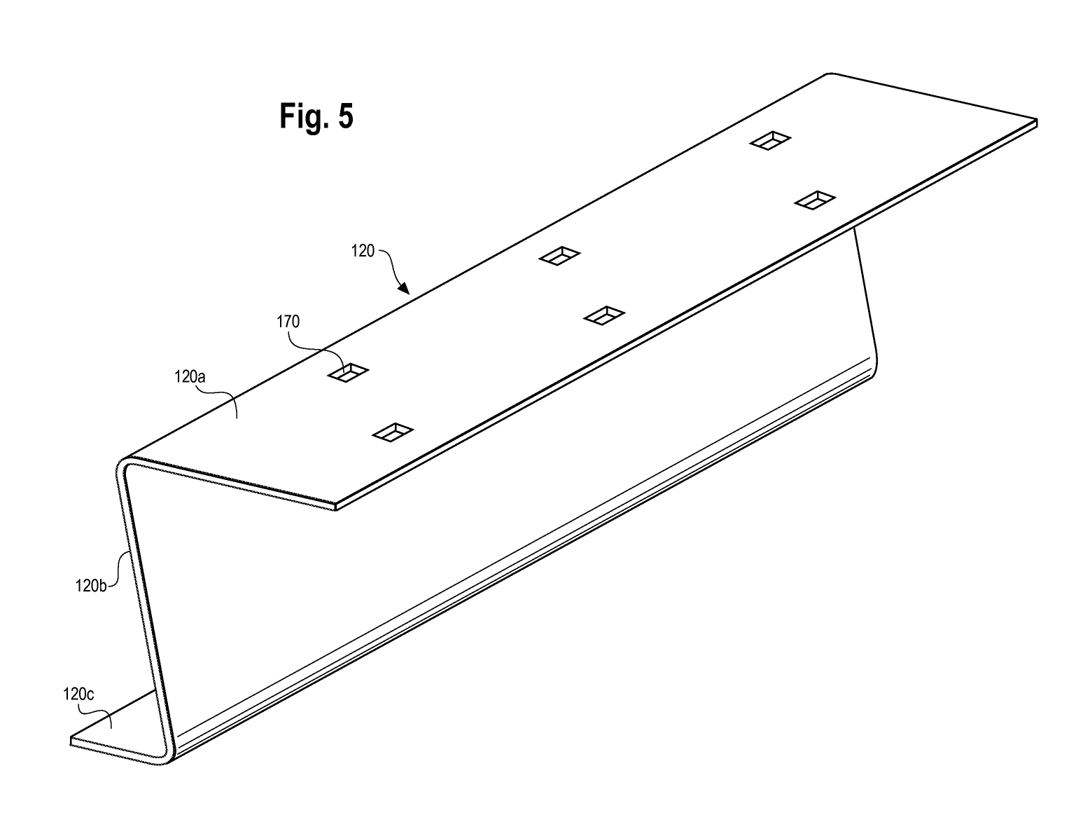

As shown in FIGS. 6A and 6B, the pallet post 110 can include a plurality of keyholes 175 adapted to receive the protrusion 140 of the pallet connector 130. The keyholes 175 can be teardrop-shaped to allow the head of the protrusion 140 to insert into a larger portion 175a of the keyhole, and to then slide into a smaller portion of the keyhole 175b where the neck 140a of the protrusion can rest. As shown, the keyholes 175 are aligned on the pallet post 110 in two rows, but one of ordinary skill would appreciate that any number of rows, including one row, can be utilized without departing from the spirit and scope of the present application.

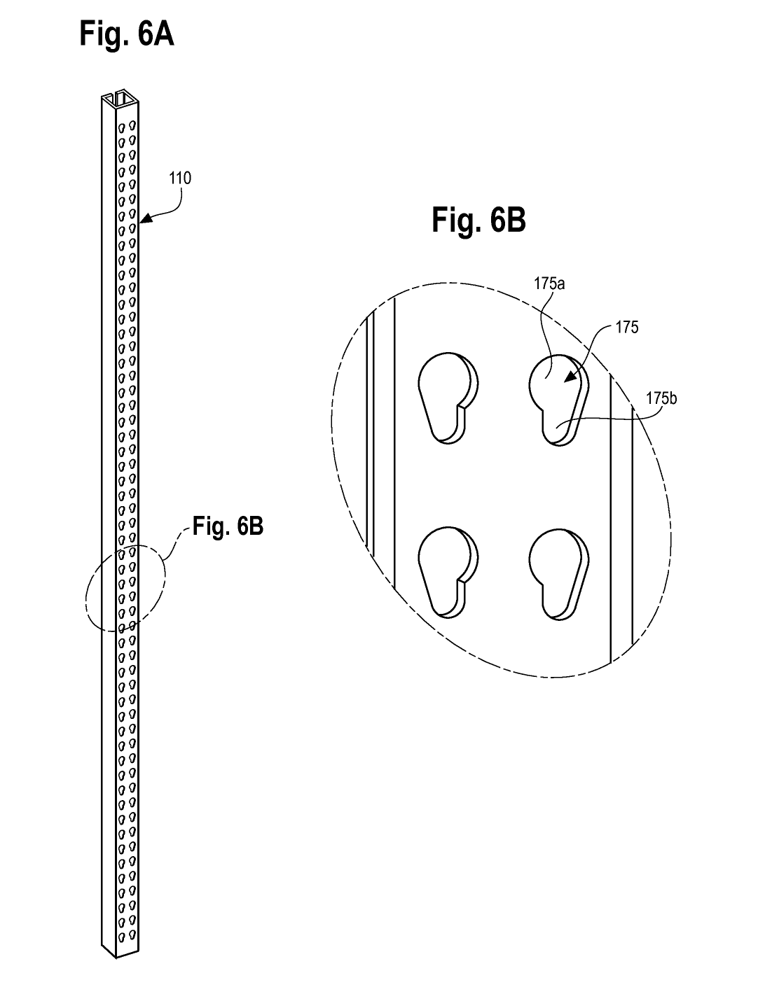

FIGS. 7A and 7B illustrate a bulk post 115 according to an embodiment of the present application. As shown, the bulk post 115 includes a row of elongated, generally trapezoidal engagement portions 180 each adapted to receive one of the fingers 165 from the bulk connector 125. However, any shaped engagement portion 180 can be utilized as long as the engagement portion can receive and releasably engage one of the fingers 165. In an embodiment, the engagement portion 165 can have a first dimension A larger than a second dimension B to accommodate the elongated finger 165 when inserted into the engagement portion 180. For example, the finger 165 can be inserted into the engagement portion 180 by first inserting the cam portion 165b into the engagement portion 180, and rotating the bulk connector 125 until the main face 150 is substantially flush against a side of the bulk post 115.

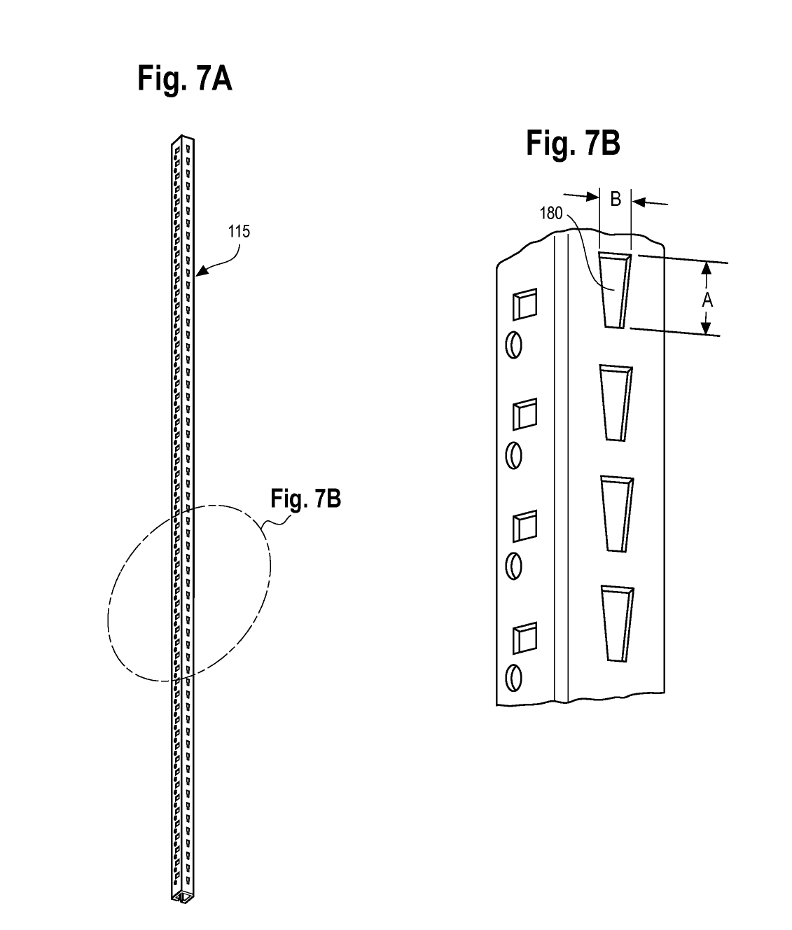

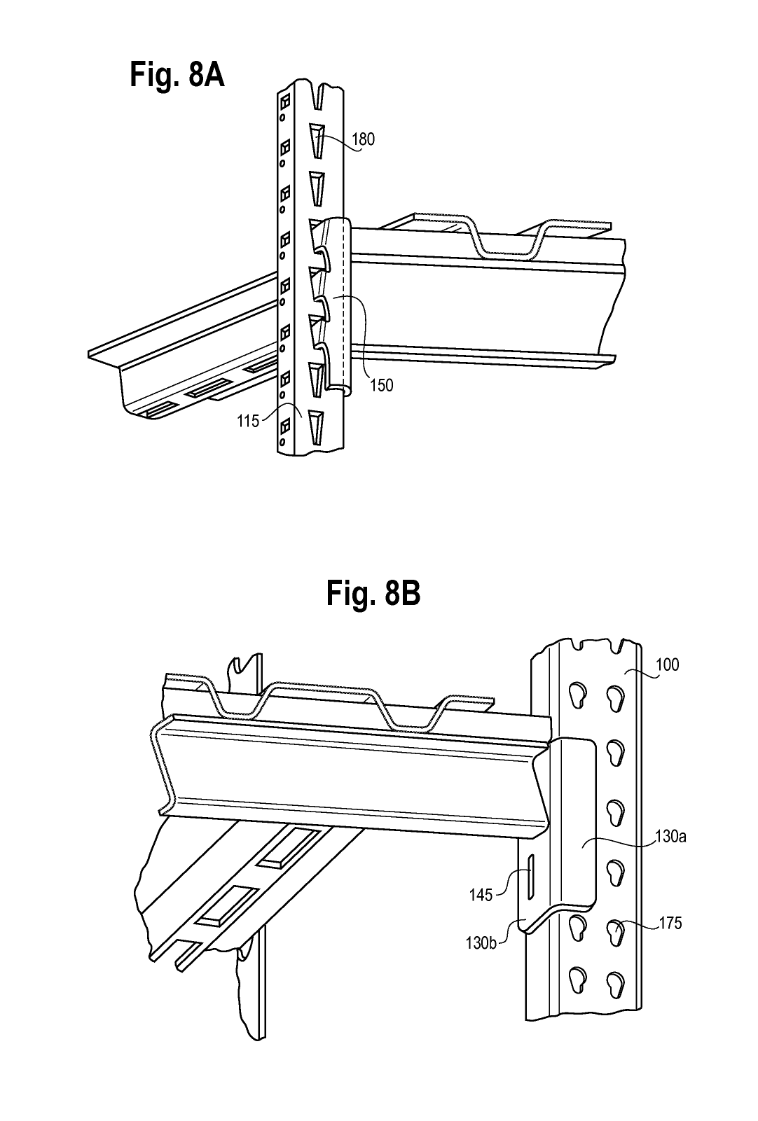

As shown in FIGS. 8A and 8B, the pallet connector 130 and bulk connector 125 can be coupled to the pallet post 110 and bulk post 115, respectively, such that the fingers 165 and the protrusions 140 extend in a direction perpendicular to the direction in which the beam 120 extends. When connected, the first face 130a of the pallet connector 130 is substantially flush with and abuts a face of the pallet post 110 with the protrusions 140 engaged within the keyholes 175. Similarly, when connected, the main face 150 of the bulk connector 125 is substantially flush with and abuts a face of the bulk post 115 with the fingers 165 engaged within the engagement portions 180. In this manner, the beam 120 having the pallet connector 130 and bulk connector 125 can be selectively coupled to the pallet post 110 or the bulk post 115 from the side, i.e., from a position substantially perpendicular to the extending direction of the beam 120.

As discussed herein, the beam 120, bulk connector 125 and pallet connector 130 are three separate components. However, it will be appreciated that the beam 120, bulk connector 125 and pallet connector 130 can be integral with one another, or can be separate from one another, as needed. Other components discussed above can also be integral with or separate from one another, or can be combined together in any manner.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A connecting structure for shelving units comprising:
a beam having first and second ends;
a bulk connector disposed at the first end and adapted to couple to an engagement portion of a bulk post, and
a pallet connector disposed at the second end and adapted to engage a keyhole of a pallet post.

2. The connecting structure of claim 1, wherein the bulk connector includes a plurality of fingers adapted to be received by the engagement portion.

3. The connecting structure of claim 2, wherein the plurality of fingers each include a main body and a cam portion extending from the main body.

4. The connecting structure of claim 1, wherein the pallet connector includes a plurality of protrusions each adapted to engage the keyhole.

5. The connecting structure of claim 4, wherein each of the plurality of protrusions includes a neck and a head extending from the neck.

6. The connecting structure of claim 2, wherein the beam extends in a first direction between the first and second ends, and the fingers extend in a second direction perpendicular to the first direction.

7. The connecting structure of claim 4, wherein the beam extends in a first direction between the first and second ends, and the protrusions extend in a second direction substantially perpendicular to the first direction.

8. A shelving system comprising:
a pallet shelf including:
a plurality of pallet posts having a keyhole; and
a platform extending between at least two of the plurality of pallet posts;
a bulk shelf including a plurality of bulk posts each including an engagement portion, and
a beam having first and second ends, a bulk connector disposed at the first end and adapted to couple to the engagement portion; and
a pallet connector disposed at the second end and adapted to engage the keyhole of one of the pallet posts.

9. The shelving system of claim 8, wherein the bulk connector includes a plurality of fingers adapted to be received by the engagement portion.

10. The shelving system of claim 9, wherein the plurality of fingers each includes a main body and a cam portion extending from the main body.

11. The shelving system of claim 8, wherein the pallet connector includes a plurality of protrusions each adapted to engage the keyhole.

12. The shelving system of claim 11, wherein each of the plurality of protrusions includes a neck and a head extending from the neck.

13. The shelving system of claim 9, wherein the beam extends in a first direction between the first and second ends, and the fingers extend in a second direction substantially perpendicular to the first direction.

14. The shelving system of claim 11, wherein the beam extends in a first direction between the first and second ends, and the protrusions extends in a second direction perpendicular to the first direction.
